(19) United States
(12) Patent Application Publication
(10) Pub. No.: US 2024/0151308 A1
(43) Pub. Date: May 9, 2024

(54) SEALING STRUCTURE AND SEALING MATERIAL

(71) Applicant: VALQUA, LTD., Tokyo (JP)

(72) Inventor: Kazuaki TSUJI, Tokyo (JP)

(21) Appl. No.: 18/548,475

(22) PCT Filed: Feb. 16, 2022
(86) PCT No.: PCT/JP2022/006134

§ 371 Date: Aug. 30, 2023

(30) Foreign Application Priority Data
Mar. 1, 2021 (JP) 2021-031492

(51) Int. Cl. F16J 15/06

(52) U.S. Cl. CPC F16J 15/061

(57) ABSTRACT

A sealing structure includes: a first sealing material; and a second sealing material having elasticity higher than elasticity of the first sealing material, and the second sealing material is covered with the first sealing material so that the second sealing material is not exposed to a side of the second sealing surface in a state where the sealing material is attached to the sealing groove. With this configuration, it is possible to provide a sealing structure and a sealing material capable of further improving a radical resistance of the sealing material.

### TECHNICAL FIELD

The present invention relates to a sealing structure and a sealing material.

### BACKGROUND ART

An isolation valve (on/off) and a pressure control valve of an exhaust system are in an open state in a normal use environment, but when an introduced gas or an exhaust gas flows, these valves are in a closed state to stop the flow of the fluid. Therefore, in normal use (in a state where the valve is opened), a sealing material is always exposed to the gas, and the sealing material is disposed under a very severe environment.

For example, a composite sealing material used in such an environment is disclosed in Japanese Patent Laying-Open No. 2018-123863 (PTL 1).

### CITATION LIST

### Patent Literature

PTL 1: Japanese Patent Laying-Open No. 2018-123863

### SUMMARY OF INVENTION

### Technical Problem

In recent years, a structure for further prolonging the life of the sealing material has been required even in use under a severe environment as described above. In particular, as described above, since the sealing material is always exposed to the gas even in normal use (in the state where the valve is opened), it is necessary to further improve a radical resistance of the sealing material even in such a use state.

The present invention is made to solve the above problem, and an object of the present invention is to provide a sealing structure and a sealing material capable of further improving a radical resistance of the sealing material.

### Solution to Problem

A sealing structure of this disclosure is a sealing structure comprising: one member having a first sealing surface; an annular sealing groove provided in the first sealing surface; a sealing material attached to the sealing groove; and another member that is disposed to face the one member, and has a second sealing surface abutting on the sealing material to configure the sealing structure, wherein the sealing material includes: a first sealing material; and a second sealing material having elasticity higher than elasticity of the first sealing material, and the second sealing material is covered with the first sealing material so that the second sealing material is not exposed to a side of the second sealing surface in a state where the sealing material is attached to the sealing groove.

In another aspect, the first sealing material includes a sealing engagement portion directed outward in a radial direction, and the sealing groove is provided with a groove engagement portion engaged with the sealing engagement portion at a position covering the sealing engagement portion when the sealing material is placed in the sealing groove.

In another aspect, the second sealing material has an annular shape as a whole and has a circular cross-sectional shape, and the first sealing material has an annular shape as a whole, and has a concave cross-sectional shape so that the second sealing material can be received, and is provided with the sealing engagement portion protruding outward.

A sealing material of this disclosure is a sealing material attached to an annular sealing groove, the sealing material comprising: a first sealing material; and a second sealing material having elasticity higher than elasticity of the first sealing material, wherein the second sealing material is covered with the first sealing material so that the second sealing material is not exposed from the sealing groove in a state where the sealing material is attached to the sealing groove.

In another aspect, the second sealing material has an annular shape as a whole and has a circular cross-sectional shape, and the first sealing material has an annular shape as a whole, and has a concave cross-sectional shape so that the second sealing material can be received, and is provided with a sealing engagement portion protruding outward.

### Advantageous Effects of Invention

With this sealing structure and this sealing material, it is possible to provide a sealing structure and a sealing material capable of further improving a radical resistance of the sealing material.

### BRIEF DESCRIPTION OF DRAWINGS

FIG. 1 is a partially enlarged cross-sectional view illustrating a sealing structure in a first embodiment.

FIG. 2 is an overall perspective view of a sealing material in the first embodiment.

FIG. 3 is an end view taken along line III-III arrow view in FIG. 2.

FIG. 4 is an end view of a sealing groove as viewed along line III-III arrow view in FIG. 2.

FIG. 5 is a partially enlarged cross-sectional view illustrating the sealing structure in the first embodiment at the sealing time.

FIG. 6 is a partially enlarged cross-sectional view illustrating a sealing structure in a second embodiment.

FIG. 7 is an overall perspective view of a sealing material in the second embodiment.

FIG. 8 is an end view taken along line VIII-VIII arrow view in FIG. 7.

FIG. 9 is an end view of a sealing groove as viewed along line VIII-VIII arrow view in FIG. 7.

FIG. 10 is a partially enlarged cross-sectional view illustrating the sealing structure in the second embodiment at the sealing time.

### DESCRIPTION OF EMBODIMENTS

A sealing structure and a sealing material in the present embodiment will be described below with reference to the drawings. In the embodiments described below, when a number, an amount, and the like are mentioned, the scope of the present invention is not necessarily limited to the number, amount, and the like unless otherwise specified. In addition, the same components and equivalent components are denoted by the same reference numerals, and redundant description may not be repeated. In the following description, for convenience of description, a positional relationship is clearly indicated by using upper and lower words, but a configuration in which the upper and lower positions are upside down and a configuration in which the upper and lower positions are arranged on the left and right sides are not excluded.

### First Embodiment

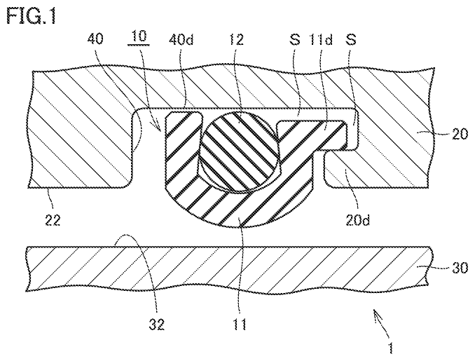

A sealing structure 1 of the present embodiment will be described with reference to FIG. 1. FIG. 1 is a partially enlarged cross-sectional view illustrating the sealing structure in the embodiment. Sealing structure 1 of the present disclosure is, for example, a sealing structure used for an exhaust valve including a pressure adjustment valve.

A sealing material 10 is disposed inside a sealing groove 40 provided in a first sealing surface 22 of one member 20 in order to configure the sealing structure between first sealing surface 22 of one member 20 located on an upper side configuring the exhaust valve and a second sealing surface 32 of another member 30 located on a lower side. A sealing material 10 of the present embodiment constitutes composite sealing including a first sealing material 11 and a second sealing material 12.

A state illustrated in FIG. 1 indicates a state (non-pressed state) where sealing material 10 is not pressed by second sealing surface 32 of other member 30. As will be described in detail later, when sealing material 10 is placed inside sealing groove 40, second sealing material 12 is covered with first sealing material 11 so that second sealing material 12 is not exposed from sealing groove 40. Further, sealing material 10 is provided with a sealing engagement portion 11d protruding outward, and sealing groove 40 is provided with a groove engagement portion 20d at a position covering sealing engagement portion 11d.

With this configuration, second sealing material 12 is suppressed from being exposed to a corrosive fluid, and sealing material 10 is prevented from falling from sealing groove 40.

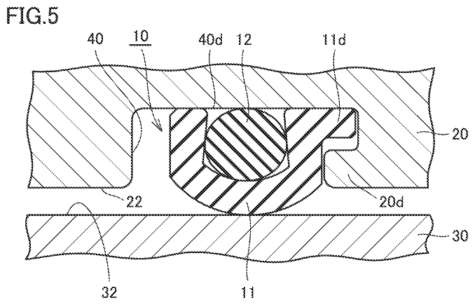

In this non-pressed state, a certain gap S is formed between an in-groove sealing surface 40d of sealing groove 40 and sealing engagement portion 11d. Similarly, certain gap S is also formed between sealing material 10 and side walls 40s of sealing groove 40. As a result, even in the state where sealing material 10 is pressed by other member 30 (pressed state) (see FIG. 5), sufficient deformation of sealing material 10 can be allowed.

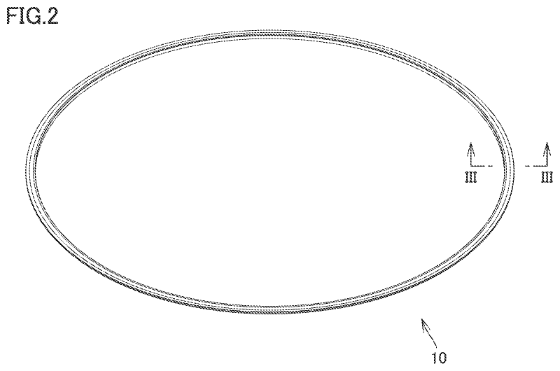

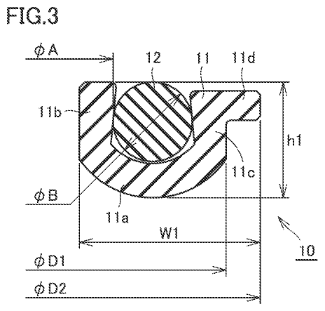

A specific configuration of sealing material 10 of the present embodiment will be described with reference to FIGS. 2 and 3. FIG. 2 is an overall perspective view of sealing material 10, and FIG. 3 is an end view taken along line II-III arrow view in FIG. 2.

An entire shape of sealing material 10 is annular, and in the present embodiment, an outer shape is about 400 mm, an inner diameter is about 390 mm, and a height is about 5 mm. Sealing material 10 is a composite sealing structure of first sealing material 11 and second sealing material 12. Hereinafter, shapes of first sealing material 11 and second sealing material 12 on a lateral end surface will be described.

A cross-sectional shape of second sealing material 12 is circular, and a diameter (φB) is about 3.5 mm. An inner diameter (φA) of second sealing material 12 is about 390 mm. Second sealing material 12 has a general O-ring form.

First sealing material 11 has a concave cross-sectional shape so that second sealing material 12 can be received from above. First sealing material 11 includes a first support portion 11a that supports second sealing material 12 from below, a second support portion 11b that supports second sealing material 12 from inside, and a third support portion 11c that supports second sealing material 12 from outside. Third support portion 11c is provided with sealing engagement portion 11d protruding outward. In the present embodiment, sealing engagement portion 11d is provided over an entire circumference, but may be partially provided.

An outer diameter dimension (φD1) of third support portion 11c is about 404 mm, and an outer diameter dimension (φD2) of sealing engagement portion 11d is about 406 mm. A height (h1) of first sealing material 11 is about 5 mm.

First support portion 11a is provided in a downward curved shape and supports second sealing material 12 from below. At least inner wall surfaces of second support portion 11b and third support portion 11c are provided so as to be tapered and narrowed upward. As a result, second sealing material 12 can be held so as to be embraced by the inner wall surfaces of first support portion 11a, second support portion 11b, and third support portion 11c.

By having the above dimensional relationship, it is desirable to set a disposition relationship in which an upper end of second sealing material 12 does not protrude from second support portion 11b in the non-pressed state as illustrated in FIG. 3. In the pressed state, second sealing material 12 is pressed to enhance a sealing performance, and sealing engagement portion 11d is pressed against in-groove sealing surface 40d of sealing groove 40, so that the sealing performance of second sealing material 12 by first sealing material 11 can be enhanced. Note that the present invention is not limited to this disposition relationship.

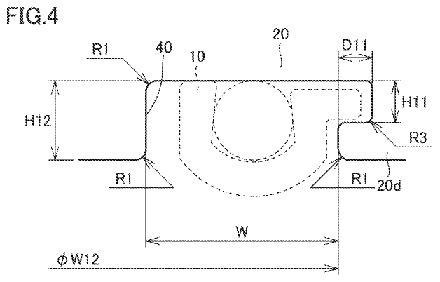

A shape of sealing groove 40 provided on a side of second sealing material 12 will be described with reference to FIG. 4. FIG. 4 is an end view as viewed along line III-III arrow view in FIG. 2. Sealing groove 40 is annularly provided without a seam with respect to second sealing material 12.

A depth (H12) of sealing groove 40 is about 3.5 mm, an opening width (W) along the radial direction is about 8.5 mm, a protrusion length (D11) of groove engagement portion 20d is about 1.5 mm, and an opening diameter ((φW12) based on a protrusion tip of groove engagement portion 20d is about 403 mm. A roundness (R1) of each corner portion is about 0.3 mm to 0.5 mm.

As described above, sealing material 10 of the present embodiment is used for an exhaust valve, but an object of first sealing material 11 is radical resistance (chemical resistance), and an object of second sealing material 12 is backup for improving sealability. Therefore, it is preferable that a function required for second sealing material 12 is higher elasticity than that of first sealing material 11. A material of first sealing material 11 is preferably a resin-based material represented by PTFE. Second sealing material 12 is preferably an elastomer material having elasticity.

Examples of the resin-based material of first sealing material 11 include one or more synthetic resins selected from a fluororesin, a polyimide resin, a polyamideimide resin, a polyetherimide resin, a polyamideimide resin, a polyphenylene sulfide resin, a polybenzimidazole resin, and a polyether ketone resin.

In particular, examples of the fluororesin, which is one of the above-mentioned synthetic resins, include a polytetrafluoroethylene (PTFE) resin, a tetrafluoroethylene-perfluoroalkyl vinyl ether copolymer (PFA) resin, a tetrafluoroethylene-hexafluoropropylene copolymer (FEP) resin, a tetrafluoroethylene-ethylene copolymer (ETFE) resin, a polyvinylidene fluoride (PVDF) resin, a polychlorotrifluoroethylene (PCTFE) resin, a chlorotrifluoroethylene-ethylene copolymer (ECTFE) resin, and a polyvinyl fluoride (PVF) resin. Among them, the polytetrafluoroethylene (PTFE) resin is preferable in consideration of heat resistance, corrosion-resistant gas, plasma resistance, and the like.

Second sealing material 12 is desirably constituted of rubber, which is an elastic member, as the elastomer material having elasticity. Note that in this case, as the rubber, either natural rubber or synthetic rubber can be used. Further, it is more desirable that the rubber constituting second sealing material 12 is constituted of fluororubber.

Examples of the fluororubber include binary vinylidene fluoride-based rubbers such as vinylidene fluoride/hexafluoropropylene-based copolymers, vinylidene fluoride/trifluorochloroethylene-based copolymers, and vinylidene fluoride/pentafluoropropylene-based copolymers; ternary vinylidene fluoride rubbers such as vinylidene fluoride/tetrafluoroethylene/hexafluoropropylene-based copolymers, vinylidene fluoride/tetrafluoroethylene/perfluoroalkyl vinyl ether-based copolymers, and vinylidene fluoride/tetrafluoroethylene/propylene-based copolymers; tetrafluoroethylene/propylene-based copolymers; tetrafluoroethylene 1 perfluoroalkyl vinyl ether-based copolymers; and thermoplastic fluorine-containing rubbers.

With such fluororubbers, even when first sealing material 11 comes into contact with the corrosive fluid, a sealing property is not deteriorated because a radical resistance to the corrosive fluid and the like is high.

Next, referring to FIG. 5, a state where sealing material 10 is pressed against other member 30 (pressed state) will be described. FIG. 5 is a partially enlarged cross-sectional view illustrating the sealing structure at the sealing time.

In a state where sealing material 10 is pressed toward a side of one member 20 by other member 30, both first sealing material 11 and second sealing material 12 are deformed so that above-described gap S disappears. At this time, first sealing material 11 is pressed against in-groove sealing surface 40d of sealing groove 40 to seal spaces between the outside and the inside. Thereafter, second sealing material 12 is pressed to enhance the sealing performance, and sealing engagement portion 11d is pressed against in-groove sealing surface 40d of sealing groove 40, so that the sealing performance of second sealing material 12 by first sealing material 11 can be enhanced. In this way, a flow path between the outside and the inside is blocked (sealed state). Since second sealing material 12 is brought into a state of being covered with first sealing material 11 rich in corrosion resistance, it is possible to suppress promotion of deterioration of second sealing material 12.

When sealing material 10 is released from the pressing by other member 30 and enters the non-pressed state, it returns to the state illustrated in FIG. 1. Although the corrosive fluid passes in this non-pressed state, second sealing material 12 is brought into a state of being covered with first sealing material 11 rich in corrosion resistance, so that it is possible to suppress the promotion of the deterioration of second sealing material 12.

In addition, as described above, sealing engagement portion 11d protruding outward is engaged with groove engagement portion 20d provided in sealing groove 40, which prevents sealing material 10 from falling.

As described above, according to the sealing structure of the present embodiment, even in the non-pressed state, in first sealing material 11 and second sealing material 12 configuring sealing material 10, second sealing material 12 is in a state of being covered with first sealing material 11 having a high radical resistance to the corrosive fluid, so that it is possible to suppress deterioration of first sealing material 11 and to improve a radical resistance as sealing material 10.

In addition, as described above, it is possible to provide sealing structure 1 and sealing material 10 in which sealing material 10 does not fall from one member 20 even when sealing material 10 is provided on one member 20 located on the upper side in the non-pressed state.

### Second Embodiment

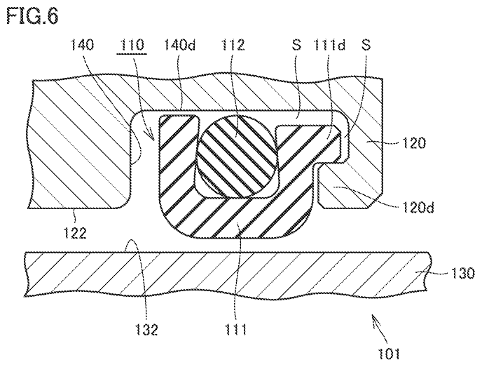

A sealing structure 101 of the present embodiment will be described with reference to FIG. 6. FIG. 6 is a partially enlarged cross-sectional view illustrating the sealing structure according to the embodiment. Sealing structure 101 of the present disclosure is used for, for example, isolation valves mounted on pipelines of other corrosive fluids such as various introduced gases, exhaust gases, and similar fluids.

A sealing material 110 is disposed inside a sealing groove 140 provided in a first sealing surface 122 of one member 120 in order to configuring the sealing structure, sealing material 110 being disposed between first sealing surface 122 of one member 120 located on an upper side, which configures an isolation valve, and a second sealing surface 132 of another member 130 located on a lower side. Sealing material 110 of the present embodiment constitutes composite sealing including a first sealing material 111 and a second sealing material 112.

A state illustrated in FIG. 6 indicates a state (non-pressed state) in which sealing material 110 is not pressed by second sealing surface 132 of other member 130. As will be described in detail later, when sealing material 110 is placed inside sealing groove 140, second sealing material 112 is covered with first sealing material 111 so that second sealing material 112 is not exposed from sealing groove 140. Further, sealing material 110 is provided with a sealing engagement portion 111d protruding outward, and sealing groove 140 is provided with a groove engagement portion 120d at a position covering sealing engagement portion 111d.

With this configuration, second sealing material 112 is suppressed from being exposed to a corrosive fluid, and sealing material 110 is prevented from falling from sealing groove 140.

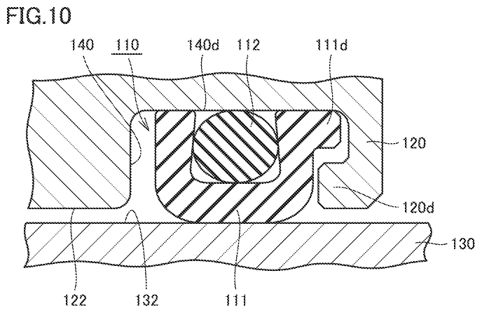

In this non-pressed state, certain gap S is formed between an in-groove sealing surface 140d of sealing groove 140 and sealing engagement portion 111d. Similarly, certain gap S is also formed between sealing material 110 and side walls 140s of sealing groove 140. As a result, even in the state where sealing material 110 is pressed by other member 130 (pressed state) (see FIG. 10), sufficient deformation of sealing material 110 can be allowed.

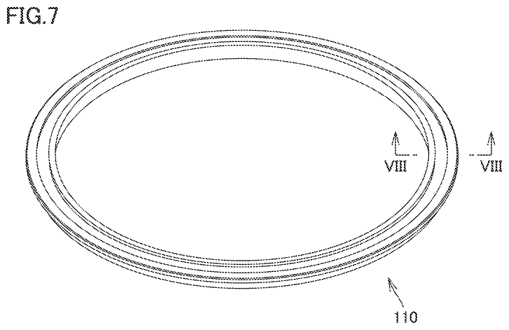

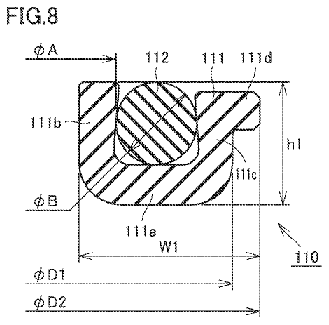

A specific configuration of sealing material 110 of the present embodiment will be described with reference to FIGS. 7 and 8. FIG. 7 is an overall perspective view of sealing material 110, and FIG. 8 is an end view taken along line VIII-VIII arrow view in FIG. 7.

An entire shape of sealing material 110 is annular, and in the present embodiment, an outer shape is about 50.2 mm, an inner diameter is about 43.4 mm, and a height is about 2.3 mm. Sealing material 110 is a composite sealing structure of first sealing material 111 and second sealing material 112. Hereinafter, shapes of first sealing material 111 and second sealing material 112 on a lateral end surface will be described.

A cross-sectional shape of second sealing material 112 is circular, and a diameter ((φB) is about 1.5 mm. An inner diameter (φA) of second sealing material 112 is about 44.9 mm. Second sealing material 112 has a general O-ring form.

First sealing material 111 has a concave cross-sectional shape so that second sealing material 112 can be received from above. First sealing material 111 includes a first support portion 111a that supports second sealing material 112 from below, a second support portion 111b that supports second sealing material 112 from inside, and a third support portion 111c that supports second sealing material 112 from outside. Third support portion 111c is provided with sealing engagement portion 111d protruding outward. In the present embodiment, sealing engagement portion 111d is provided over an entire circumference, but may be partially provided.

An outer diameter dimension (φD1) of third support portion 111c is about 49.2 mm, and an outer diameter dimension ((φD2) of sealing engagement portion 111d is about 50.2 mm. A height (h1) of first sealing material 111 is about 2.3 mm.

First support portion 111a is provided in a downward curved shape and supports second sealing material 112 from below. At least inner wall surfaces of second support portion 111b and third support portion 111c are provided so as to be tapered and narrowed upward. As a result, second sealing material 112 can be held so as to be held by the inner wall surfaces of first support portion 111a, second support portion 111b, and third support portion 111c.

By having the above dimensional relationship, it is desirable to set a disposition relationship in which an upper end of second sealing material 112 does not protrude from second support portion 111b in the non-pressed state as illustrated in FIG. 8. In the pressed state, second sealing material 112 is pressed to enhance a sealing performance, and sealing engagement portion 111d is pressed against in-groove sealing surface 140d of sealing groove 140, so that the sealing performance of second sealing material 112 by first sealing material 111 can be enhanced. Note that the present invention is not limited to this disposition relationship.

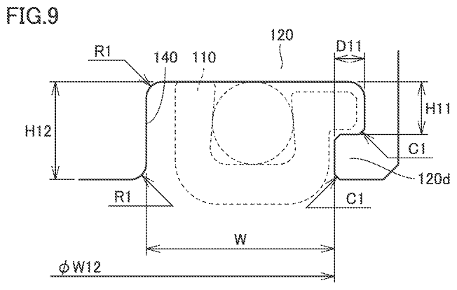

A shape of sealing groove 140 provided on a side of second sealing material 112 will be described with reference to FIG. 9. FIG. 9 is an end surface shape when viewed along line VIII-VIII arrow view in FIG. 7. Sealing groove 140 is annularly provided without a seam with respect to second sealing material 112.

A depth (H12) of sealing groove 140 is about 3.5 mm, an opening width (W) along the radial direction is about 3.55 mm, a protrusion length (D11) of groove engagement portion 120d is about 0.55 mm, and an opening diameter (φW12) based on a protrusion tip of groove engagement portion 120d is about 49.6 mm. A roundness (R1) and chamfering (C1) of each corner portion are about 0.1 mm to 0.3 mm.

As described above, sealing material 110 of the present embodiment is used for an isolation valve, but an object of first sealing material 111 is radical resistance (chemical resistance), and an object of second sealing material 112 is backup for improving sealability. Therefore, it is preferable that a function required for second sealing material 112 is higher elasticity than that of first sealing material 112. A material of first sealing material 111 is preferably a resin-based material represented by PTFE. Second sealing material 112 is preferably an elastomer material having elasticity.

Examples of the resin-based material of first sealing material 111 include one or more synthetic resins selected from a fluororesin, a polyimide resin, a polyamideimide resin, a polyetherimide resin, a polyamideimide resin, a polyphenylene sulfide resin, a polybenzimidazole resin, and a polyether ketone resin.

In particular, examples of the fluororesin, which is one of the above-mentioned synthetic resins, include a polytetrafluoroethylene (PTFE) resin, a tetrafluoroethylene-perfluoroalkyl vinyl ether copolymer (PFA) resin, a tetrafluoroethylene-hexafluoropropylene copolymer (FEP) resin, a tetrafluoroethylene-ethylene copolymer (ETFE) resin, a polyvinylidene fluoride (PVDF) resin, a polychlorotrifluoroethylene (PCTFE) resin, a chlorotrifluoroethylene-ethylene copolymer (ECTFE) resin, and a polyvinyl fluoride (PVF) resin. Among them, the polytetrafluoroethylene (PTFE) resin is preferable in consideration of heat resistance, corrosion-resistant gas, plasma resistance, and the like.

Second sealing material 112 is desirably constituted of rubber which is an elastic member as the elastomer material having elasticity. Note that in this case, as the rubber, either natural rubber or synthetic rubber can be used. Further, it is more desirable that the rubber constituting second sealing material 112 is constituted of fluororubber.

Examples of the fluororubber include binary vinylidene fluoride-based rubbers such as vinylidene fluoride/hexafluoropropylene-based copolymers, vinylidene fluoride/trifluorochloroethylene-based copolymers, and vinylidene fluoride/pentafluoropropylene-based copolymers; ternary vinylidene fluoride rubbers such as vinylidene fluoride/tetrafluoroethylene/hexafluoropropylene-based copolymers, vinylidene fluoride/tetrafluoroethylene/perfluoroalkyl vinyl ether-based copolymers, and vinylidene fluoride/tetrafluoroethylene/propylene-based copolymers; tetrafluoroethylene/propylene-based copolymers; tetrafluoroethylene 1 perfluoroalkyl vinyl ether-based copolymers; and thermoplastic fluorine-containing rubbers.

With such fluororubbers, even when first sealing material 111 comes into contact with the corrosive fluid, a sealing property is not deteriorated because a radical resistance to the corrosive fluid and the like is high.

Next, referring to FIG. 10, a state where sealing material 110 is pressed against other member 130 (pressed state) will be described. FIG. 10 is a partially enlarged cross-sectional view illustrating the sealing structure at the sealing time.

In a state where sealing material 110 is pressed toward a side of one member 120 by other member 130, both first sealing material 111 and second sealing material 112 are deformed so that above-described gap S disappears. At this time, first sealing material 111 is pressed against in-groove sealing surface 140d of sealing groove 140 to seal spaces between the outside and the inside. Thereafter, second sealing material 112 is pressed to enhance a sealing performance, and sealing engagement portion 111d is pressed against in-groove sealing surface 140d of sealing groove 140, so that the sealing performance of second sealing material 112 by first sealing material 111 can be enhanced. In this way, a flow path between the outside and the inside is blocked (sealed state). Since second sealing material 112 is brought into a state of being covered with first sealing material 111 rich in corrosion resistance, it is possible to suppress promotion of deterioration of second sealing material 112.

When sealing material 110 is released from the pressing by other member 130 and enters the non-pressed state, the state returns to the state illustrated in FIG. 6. Although the corrosive fluid passes in this non-pressed state, second sealing material 112 is brought into a state of being covered with first sealing material 111 rich in corrosion resistance, so that it is possible to suppress the promotion of the deterioration of second sealing material 112.

In addition, as described above, sealing engagement portion 111d protruding outward is engaged with groove engagement portion 120d provided in sealing groove 140, which prevents sealing material 110 from falling.

As described above, according to the sealing structure of the present embodiment, even in the non-pressed state, in first sealing material 111 and second sealing material 112 constituting sealing material 110, second sealing material 112 is in a state of being covered with first sealing material 111 having a high radical resistance to the corrosive fluid, so that it is possible to suppress deterioration of first sealing material 111 and to improve a radical resistance as sealing material 110.

In addition, as described above, it is possible to provide sealing structure 101 and sealing material 110 in which sealing material 110 does not fall from one member 120 even when sealing material 110 is provided on one member 120 located on the upper side in the non-pressed state.

It should be considered that the embodiments disclosed this time are examples in all respects and are not restrictive. The scope of the present invention is defined not by the description above but by the claims, and it is intended that all modifications within meaning and scope equivalent to the claims are included.

### REFERENCE SIGNS LIST

1, 101: sealing structure, 10, 110: sealing material, 11, 111: first sealing material, 11a, 111a: first support portion, 11b, 111b: second support portion, 11c, 111c: third support portion, 11d, 111d: sealing engagement portion, 12, 112: second sealing material, 20, 120: one member, 20d, 120d: groove engagement portion, 22, 122: first sealing surface, 30, 130: other member, 32, 132: second sealing surface, 40, 140: sealing groove, 40d, 140d: in-groove sealing surface, 40s, 140s: side wall

1. A sealing structure comprising:
one member having a first sealing surface;
an annular sealing groove provided in the first sealing surface;
a sealing material attached to the sealing groove; and
another member that is disposed to face the one member, and has a second sealing surface abutting on the sealing material to configure the sealing structure,
wherein the sealing material includes:
a first sealing material; and a second sealing material having elasticity higher than elasticity of the first sealing material, and
the second sealing material is covered with the first sealing material so that the second sealing material is not exposed to a side of the second sealing surface in a state where the sealing material is attached to the sealing groove.

2. The sealing structure according to claim 1,
wherein the first sealing material includes a sealing engagement portion directed outward in a radial direction, and
the sealing groove is provided with a groove engagement portion engaged with the sealing engagement portion at a position covering the sealing engagement portion when the sealing material is placed in the sealing groove.

3. The sealing structure according to claim 1,
wherein the second sealing material has an annular shape as a whole and has a circular cross-sectional shape, and
the first sealing material has an annular shape as a whole, and has a concave cross-sectional shape so that the second sealing material can be received, and is provided with the sealing engagement portion protruding outward.

4. A sealing material attached to an annular sealing groove, the sealing material comprising:
a first sealing material; and a second sealing material having elasticity higher than elasticity of the first sealing material,
wherein the second sealing material is covered with the first sealing material so that the second sealing material is not exposed from the sealing groove in a state where the sealing material is attached to the sealing groove.

5. The sealing material according to claim 4,
wherein the second sealing material has an annular shape as a whole and has a circular cross-sectional shape, and
the first sealing material has an annular shape as a whole, and has a concave cross-sectional shape so that the second sealing material can be received, and is provided with a sealing engagement portion protruding outward.
